(19) United States
(12) Patent Application Publication
(10) Pub. No.: US 2026/0009638 A1
(43) Pub. Date: Jan. 8, 2026

(54) APPARATUS AND METHOD FOR MEASURING SIX DEGREES OF FREEDOM

(71) Applicant: AGENCY FOR DEFENSE DEVELOPMENT, Daejeon (KR)

(72) Inventors: Keum Yong PARK, Sejong-si (KR); Seung Heon YANG, Sejong-si (KR)

(73) Assignee: AGENCY FOR DEFENSE DEVELOPMENT, Daejeon (KR)

(21) Appl. No.: 19/257,696

(22) Filed: Jul. 2, 2025

(30) Foreign Application Priority Data
Jul. 2, 2024 (KR) 10-2024-0087149

(51) Int. Cl. G01B 21/16

(52) U.S. Cl. CPC G01B 21/16

(57) ABSTRACT

An apparatus for measuring six degrees of freedom according to an embodiment may include a base platform placed on a lower side, a movable platform installed above and spaced apart from the base platform, and on which a target to be measured for six degrees of freedom is placed, six contact-type displacement sensors connected between six points that are radially spaced apart on respective portions of the base platform and the movable platform with respect to a vertical direction perpendicular to the ground, and capable of extending or contracting in a longitudinal direction of the respective contact-type displacement sensors, and a controller configured to calculate six degrees of freedom of the target through a numerical optimization method, based on values measured by the six contact-type displacement sensors.

### CROSS-REFERENCE TO RELATED APPLICATION

This application claims the benefit of Korean Patent Application No. 10-2024-0087149, filed on Jul. 2, 2024, in the Korean Intellectual Property Office, the entire disclosure of which is incorporated herein by reference for all purposes.

### BACKGROUND

### Field of the Invention

One or more embodiments relate to an apparatus and method for measuring six degrees of freedom.

### Description of the Related Art

Contact- or non-contact-type systems for measuring six degrees of freedom are used as equipment to quantitatively identify the six degrees of freedom of a measurement target, namely, linear and rotational displacements in the x, y, and z directions.

These contact- or non-contact-type systems for measuring six degrees of freedom commonly have complex installation processes, their measurement precision is greatly affected by the surrounding environment (such as temperature and illumination), and high purchase costs are required.

Additionally, measurement specialists with dedicated training in hardware and software, as well as relevant operational experience, are required in order to ensure smooth equipment operation and measurement reliability. Accordingly, in industrial sites that may be exposed to various working environments, there is a limitation in applying expensive equipment in a timely manner when needed.

The above description is information the inventor(s) acquired during the course of conceiving the present disclosure, or already possessed at the time, and is not necessarily art publicly known before the present application was filed.

### SUMMARY

Embodiments provide an apparatus and method for measuring six degrees of freedom.

According to an aspect, there is provided an apparatus for measuring six degrees of freedom according to an embodiment, the apparatus including: a base platform placed on a lower side; a movable platform installed above and spaced apart from the base platform, and on which a target to be measured for six degrees of freedom is placed; six contact-type displacement sensors connected between six points that are radially spaced apart on respective portions of the base platform and the movable platform with respect to a vertical direction perpendicular to the ground, and capable of extending or contracting in a longitudinal direction of the respective contact-type displacement sensors; and a controller configured to calculate six degrees of freedom of the target through a numerical optimization method, based on values measured by the six contact-type displacement sensors.

Each of the six contact-type displacement sensors may include: a cylinder body; and a sliding rod having one end slidably inserted into the cylinder body and the other end protruding from the cylinder body, wherein respective end portions of the cylinder body and the sliding rod may be rotatably connected between the base platform and the movable platform.

The contact-type displacement sensors may include a linear potentiometer, a linear variable differential transformer (LVDT), or a linear gauge.

A lower end portion of the cylinder body may be rotatably connected to the base platform, and an upper end portion of the sliding rod may be rotatably connected to the movable platform.

The controller may be configured to estimate values of six degrees of freedom of the target by using a Gauss-Newton method, based on length vector information measured by the six contact-type displacement sensors.

The apparatus for measuring six degrees of freedom according to an embodiment may further include an initialization mechanism installed between the base platform and the movable platform, and configured to support the movable platform so as to be horizontally spaced apart from the base platform by a predetermined distance.

The initialization mechanism may include: three support rods extending in a vertical direction, and installed radially spaced apart from each other with respect to a central axis parallel to the vertical direction; a connecting frame configured to interconnect the three support rods; and spherical contact portions installed at both end portions of each of the three support rods, wherein at least two of three spherical contact portions in contact with the movable platform may be installed to be height-adjustable with respect to their respective support rods.

According to another aspect, there is provided a method of measuring six degrees of freedom of a target by using an apparatus for measuring six degrees of freedom, the apparatus including: a base platform placed on a lower side; a movable platform installed above and spaced apart from the base platform, and on which the target to be measured for six degrees of freedom is placed; and six contact-type displacement sensors configured to connect portions that are radially spaced apart from each other on respective portions of the base platform and the movable platform, wherein the method may include: defining a six-degree-of-freedom model of the target based on a length vector of the six contact-type displacement sensors; measuring values from the six contact-type displacement sensors; and determining values of six degrees of freedom of the target by using a numerical optimization method, based on the length vector measured by the six contact-type displacement sensors and the six-degree-of-freedom model.

In the defining of a six-degree-of-freedom model of the target, the six-degree-of-freedom model may be defined by the following equation:

$${L}_{i} = P + R {b}_{i} - {A}_{i} ,$$

wherein Lᵢ denotes a length vector of a contact-type displacement sensor, Aᵢ denotes a vector from the center of the base platform to an attachment point of the contact-type displacement sensor, bᵢ denotes a vector from a target point on the movable platform to the attachment point of the contact-type displacement sensor, P denotes [x, y, z]^{T}, a position vector of the target, R denotes a rotation matrix of the target, and i denotes an index of the contact-type displacement sensor (1, 2, . . . , 6).

In the determining of values of six degrees of freedom of the target, the values of six degrees of freedom of the target may be estimated by using a Gauss-Newton method, based on length vector information measured by the six contact-type displacement sensors.

In the determining of values of six degrees of freedom of the target, a Jacobian matrix between the length vector of the six contact-type displacement sensors and a vector of values of six degrees of freedom of the target may be defined by the following equation:

$$J = {[ \begin{matrix}{d}_{1} & {d}_{2} … & {d}_{6} \\ {Rb}_{1} \times {d}_{1} & {Rb}_{2} \times {d}_{2} … & {Rb}_{6} \times {d}_{6}\end{matrix} ]}^{T} ,$$

wherein J denotes the Jacobian matrix, dᵢ denotes a unit direction vector of a displacement sensor (Lᵢ/lᵢ), bᵢ denotes a vector from a target point on the movable platform to an attachment point of the contact-type displacement sensor (u-v-w), and R denotes a rotation matrix of the target.

The determining of values of six degrees of freedom of the target may include performing an iterative method to obtain the values of six degrees of freedom of the target, such that a cost function value, which is defined as the sum of squared differences between the length vector measured by the six displacement sensors and a length vector calculated from the six-degree-of-freedom model, is minimized.

The method of measuring six degrees of freedom, according to an embodiment, may further include performing initialization to adjust a horizontal state of the movable platform so that the movable platform is horizontal with respect to the ground, and to set posture or sensor values of a plurality of contact-type displacement sensors to an initial state.

According to embodiments, an apparatus and method for measuring six degrees of freedom replaces the actuators of a conventional stewart platform with contact-type displacement sensors, and enables a complex kinematics problem of obtaining six degrees of freedom of a target, based on length information measured by the contact-type displacement sensors, to be calculated in a relatively simplified manner using numerical optimization techniques.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a perspective view of an apparatus for measuring six degrees of freedom according to an embodiment.

FIG. 2 is a diagram illustrating a structure of a contact-type displacement sensor according to an embodiment.

FIG. 3 is a block diagram of an apparatus for measuring six degrees of freedom according to an embodiment.

FIG. 4 is a perspective view of an initialization mechanism according to an embodiment.

FIG. 5 is a perspective view of an apparatus for measuring six degrees of freedom and an initialization mechanism according to an embodiment.

FIG. 6 is a flowchart of a method of measuring six degrees of freedom, according to an embodiment.

FIG. 7 is a diagram illustrating a three-dimensional vector space of an apparatus for measuring six degrees of freedom, according to an embodiment.

FIG. 8 is a flowchart of determining six degrees of freedom according to an embodiment.

### DETAILED DESCRIPTION

Hereinafter, embodiments will be described in detail with reference to the accompanying drawings. The following description describes one of several aspects of the embodiments, and the following description forms part of the detailed description of the embodiments.

However, in the description of an embodiment, any detailed description of a well-known function or configuration is not included to clearly convey the gist of the present disclosure.

In addition, the terms or words used to describe the present disclosure and claims should not be construed in a conventional or dictionary meaning, and based on a principle that the inventor may properly define the concept of terms in order to best describe their invention, the terms or words should be construed as having meanings and concepts consistent with the technical idea of an apparatus and method for measuring six degrees of freedom according to an embodiment.

Accordingly, the embodiments described in the present disclosure and the configurations illustrated in the drawings merely represent the most preferred embodiments of an apparatus and method for measuring six degrees of freedom according to an embodiment, and do not encompass the full scope of the technical ideas of the apparatus and method for measuring six degrees of freedom. Therefore, it should be understood that various equivalents and modifications capable of replacing these embodiments may be made as of the filing date of the present application.

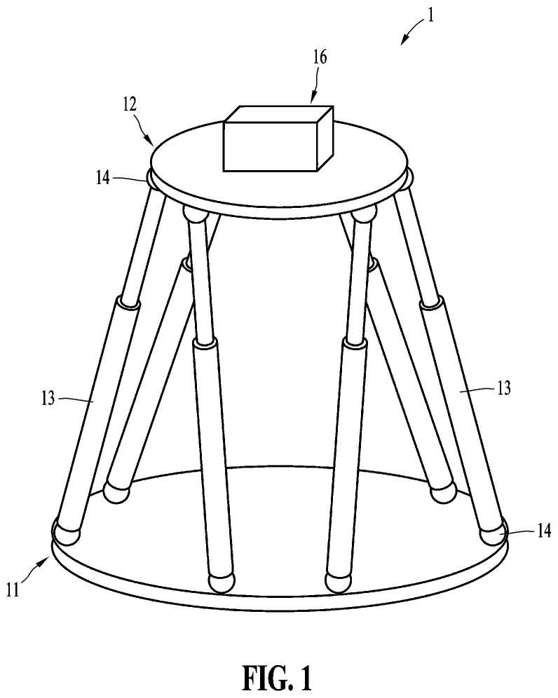

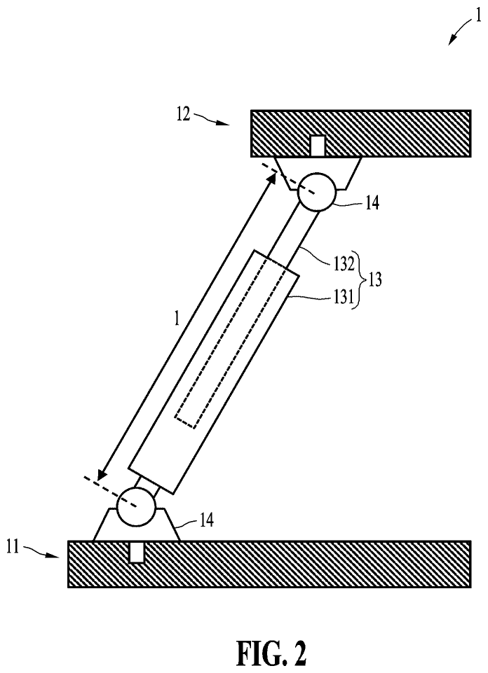

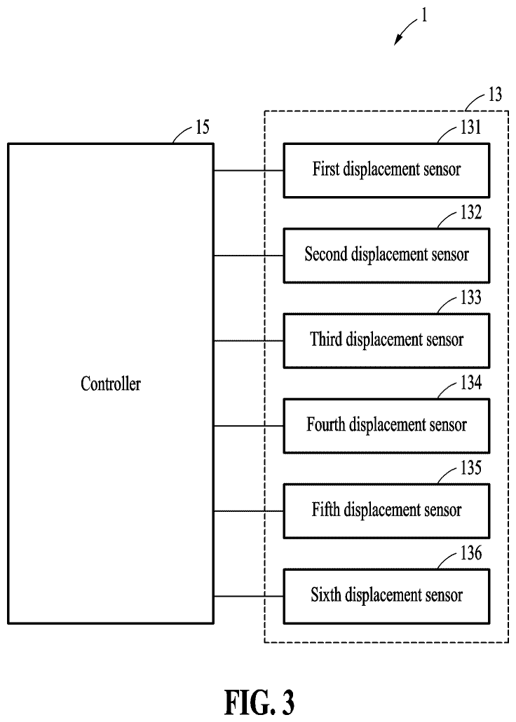

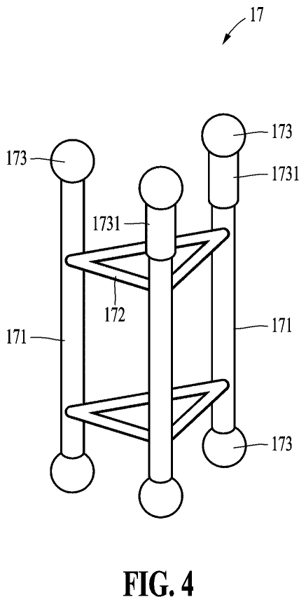

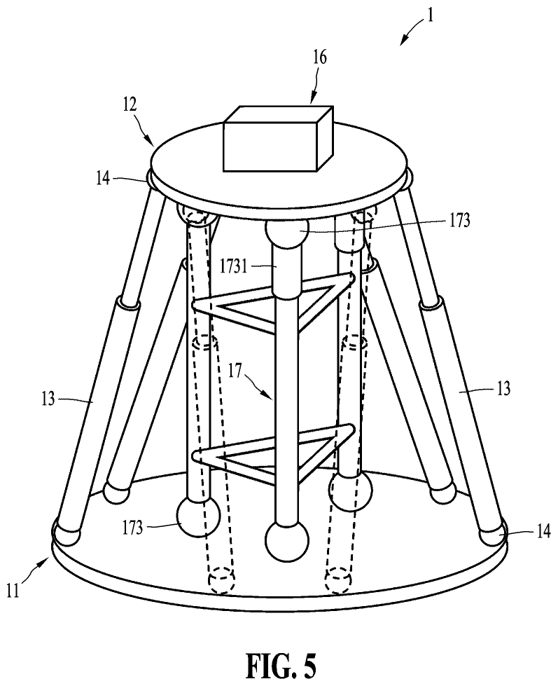

FIG. 1 is a perspective view of an apparatus for measuring six degrees of freedom according to an embodiment, FIG. 2 is a diagram illustrating a structure of a contact-type displacement sensor according to an embodiment, FIG. 3 is a block diagram of an apparatus for measuring six degrees of freedom according to an embodiment, FIG. 4 is a perspective view of an initialization mechanism according to an embodiment, and FIG. 5 is a perspective view of an apparatus for measuring six degrees of freedom and an initialization mechanism according to an embodiment.

Referring to FIGS. 1 to 5, a configuration of an apparatus for measuring six degrees of freedom 1 according to an embodiment can be confirmed.

The apparatus for measuring six degrees of freedom 1 according to an embodiment may include a base platform 11; a movable platform 12 installed above and spaced apart from the base platform 11, and on which a target 16 to be measured for six degrees of freedom is placed; six contact-type displacement sensors 13 connected between six points that are radially spaced apart on respective portions of the base platform 11 and the movable platform 12 with respect to a vertical direction perpendicular to the ground; a joint connection part 14 connected between both end portions of the contact-type displacement sensor 13 and each of the base platform 11 and the movable platform 12; an initialization mechanism 17 configured to support the movable platform 12 so as to be horizontally spaced apart from the base platform 11 by a predetermined distance; and a controller 15 configured to calculate six degrees of freedom of the target 16 through a numerical optimization method, based on values measured by a plurality of six contact-type displacement sensors.

The base platform 11 may provide a reference for the relative movement of the movable platform 12. For example, the base platform 11 may be fixed to the ground in a horizontal state, on the lower side of the movable platform 12.

For example, the base platform 11 may be a plate-shaped member forming the bottom of the apparatus for measuring six degrees of freedom 1.

The movable platform 12 may be supported in a state of being above and spaced apart from the base platform 11 through the six contact-type displacement sensors 13. For example, the base platform 11 may be a plate-shaped member.

A target 16 may be placed at the center of the movable platform 12. The movable platform 12 is capable of performing six-degree-of-freedom movement while being supported by the six contact-type displacement sensors 13.

The contact-type displacement sensor 13 may be rotatably installed between the base platform 11 and the movable platform 12, and at least a portion of the contact-type displacement sensor 13 may extend or contract in a longitudinal direction of the contact-type displacement sensor 13.

For example, the contact-type displacement sensor 13 may be connected to both the base platform 11 and the movable platform 12 via the joint connection part 14 at each end portion of the contact-type displacement sensor 13.

For example, the contact-type displacement sensor 13 may be a contact-type linear displacement sensor in which a contact end portion is pressed and displaced in a longitudinal direction of the contact-type displacement sensor 13. For example, the contact-type displacement sensor 13 may include a linear potentiometer, a linear variable differential transformer (LVDT), or a linear gauge.

The contact-type displacement sensor 13 may support the movable platform 12 so as to be movable with respect to the base platform 11, while measuring a linear length, that is, a linear displacement, which changes according to the movement of the movable platform 12.

For example, the contact-type displacement sensor 13 may include a cylinder body 131 extended in a longitudinal direction of the contact-type displacement sensor 13; and a sliding rod 132 having one end slidably inserted into the cylinder body 131 and the other end protruding from the cylinder body 131.

For example, a lower end portion of the cylinder body 131 may be rotatably connected to the base platform 11, and an upper end portion of the sliding rod 132 may be rotatably connected to the movable platform 12.

For example, the sliding rod 132 may serve as the contact end portion of the contact-type displacement sensor 13, that is, a probe.

For example, the contact-type displacement sensors 13 may be configured as a set of six sensors that connect six points radially spaced apart from each other along respective edge portions of the base platform 11 and the movable platform 12.

For example, when the apparatus for measuring six degrees of freedom 1 is viewed from above in a direction perpendicular to the ground, the points where the six contact-type displacement sensors 13 are connected to each of the base platform 11 and the movable platform 12 may respectively form a hexagonal structure.

According to the above-mentioned structure, the apparatus for measuring six degrees of freedom 1 may have a hexapod (stewart platform) robot structure that implements a parallel mechanism through the six contact-type displacement sensors 13.

For example, the six contact-type displacement sensors 13 may include a first displacement sensor 131, a second displacement sensor 132, a third displacement sensor 133, a fourth displacement sensor 134, a fifth displacement sensor 135, and a sixth displacement sensor 136.

The joint connection part 14 may be installed at portions where the respective end portions of the contact-type displacement sensor 13 are connected to the base platform 11 and the movable platform 12, respectively.

For example, the joint connection part 14 may be a joint member that rotatably connects between each of the two end portions of the contact-type displacement sensor 13 and the base platform 11 or the movable platform 12 to which the end portion is connected.

For example, the joint connection part 14 may be a ball joint or a universal joint.

For example, as shown in FIG. 2, the joint connection part 14 may be installed at a portion where the sliding rod 132 of the contact-type displacement sensor 13 is connected to the movable platform 12, and also at a portion where the cylinder body 131 of the contact-type displacement sensor 13 is connected to the base platform 11.

The controller 15 may calculate the six degrees of freedom of the target 16 by using a numerical optimization method, based on displacement values measured by a plurality of contact-type displacement sensors 13.

For example, the controller 15 may obtain length vector information from each of the six contact-type displacement sensors 13 and calculate the six degrees of freedom of the target 16 from the length vector information.

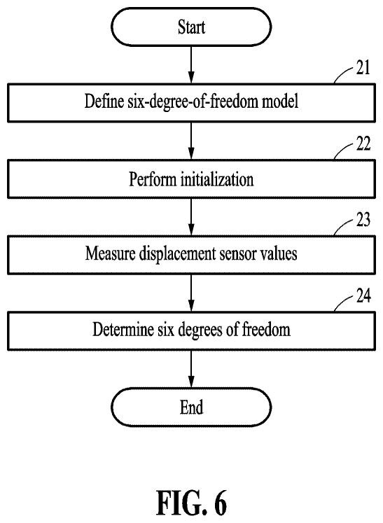

A specific method of calculating the six degrees of freedom of the target 16 through the controller 15 is described below using the description of the embodiments of FIGS. 6 to 8 below.

The initialization mechanism 17 may be used to set the initial position and posture of the apparatus for measuring six degrees of freedom 1, as well as those of the six contact-type displacement sensors 13.

The primary function of the initialization mechanism 17 may be to set the initial posture of the apparatus for measuring six degrees of freedom 1 by securing and maintaining the initial displacement repeatability of the six contact-type displacement sensors 13. The initialization mechanism 17 may also function as an inspection mechanism capable of periodically checking for abnormalities in the contact-type displacement sensors 13.

For example, the initialization mechanism 17 may include three support rods 171 extending in a vertical direction, and installed radially spaced apart from each other with respect to a central axis parallel to the vertical direction, a connecting frame 172 configured to interconnect the three support rods 171, and spherical contact portions 173 installed at both end portions of each of the three support rods 171.

For example, at least two of three spherical contact portions 173 in contact with the movable platform 12 may be height-adjustable with respect to their respective support rods 171, thereby enabling fine horizontal adjustment of the movable platform 12.

In this case, a portion of the spherical contact portion 173 may include a height adjustment portion 1731 that is slidably connected along the support rod 171 as shown in FIG. 4.

Referring to FIG. 5, for initialization of the apparatus for measuring six degrees of freedom 1, the initialization mechanism 17 may be placed between the base platform 11 and the movable platform 12. By bringing the three spherical contact portions 173, located at the upper end of the initialization mechanism 17, into contact with the lower surface of the movable platform 12 by using the weight of the target 16 and the movable platform 12, the horizontal state of the movable platform 12 may be set, while simultaneously setting posture or sensor values of a plurality of contact-type displacement sensors 13 to an initial state.

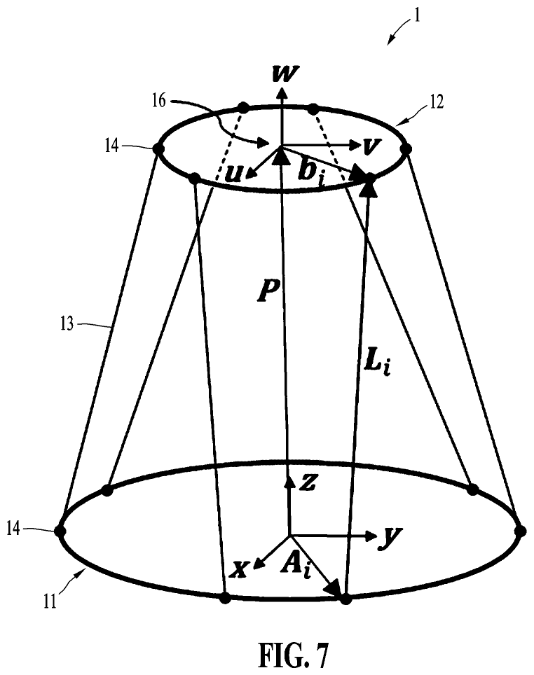

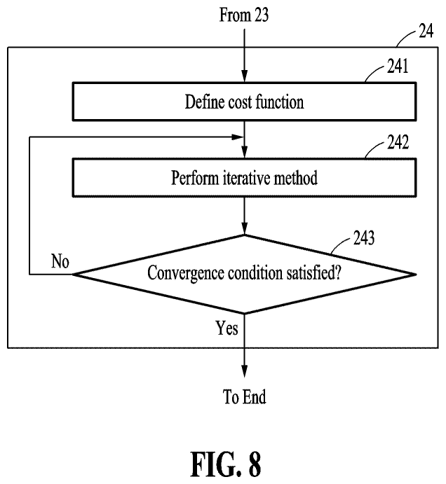

FIG. 6 is a flowchart of a method of measuring six degrees of freedom, according to an embodiment, FIG. 7 is a diagram illustrating a three-dimensional vector space of an apparatus for measuring six degrees of freedom, according to an embodiment, and FIG. 8 is a flowchart of determining six degrees of freedom according to an embodiment.

Referring to FIGS. 6 to 8, a method of measuring six degrees of freedom, according to an embodiment, may be a method of measuring six degrees of freedom of a target 16 installed at a movable platform 12 by using an apparatus for measuring six degrees of freedom 1 according to an embodiment shown in FIGS. 1 to 5.

The method of measuring six degrees of freedom, according to an embodiment, may include defining 21 a six-degree-of-freedom model, performing 22 initialization, measuring 23 values from contact-type displacement sensors, and determining 24 six degrees of freedom of a target.

The defining 21 of a six-degree-of-freedom model may involve defining the relationship between a length vector of six contact-type displacement sensors 13 and a position vector and rotation matrix of a target 16 through inverse kinematics for an apparatus for measuring six degrees of freedom on which the target 16 is installed.

First, as shown in FIG. 7, a model equation (vector equation) according to the relationship between the six degrees of freedom (x, y, and z denote target positions and φ, θ, and ψ denote target rotation angles) of the target 16 placed on the movable platform 12 and the length of the contact-type displacement sensor 13 may be expressed by Equation 1 below.

$${L}_{i} = P + R {b}_{i} - {A}_{i} , \qquad [ Equation 1 ]$$

wherein Lᵢ denotes a length vector of a contact-type displacement sensor, Aᵢ denotes a vector from the center of the base platform to an attachment point of the displacement sensor, bᵢ denotes a vector from a target point on the movable platform to the attachment point of the displacement sensor, P denotes [x, y, z]^{T}, a position vector of the target, R denotes a rotation matrix of the target, and i denotes an index of the displacement sensor (1, 2, . . . , 6).

Here, the length l of the contact-type displacement sensor 13 means the distance between the joint connection parts 14 connected to each of the two end portions of the contact-type displacement sensor 13 as shown in FIG. 2, and may be determined by the size of the length vector of the contact-type displacement sensor 13 as shown in Equation 2 below.

$${l}_{i} = \vert {L}_{i} \vert , \qquad [ Equation 2 ]$$

wherein Lᵢ denotes the length vector of the contact-type displacement sensor, and lᵢ denotes a distance vector of the contact-type displacement sensor.

Additionally, the rotation matrix R may include the degree of inclination of the measurement target in the roll, pitch, and yaw directions, that is, the rotation angles (φ, θ, and ψ), and may be expressed as the inner product of rotation matrices in each of the x, y, and z directions, as shown in Equations 3 and 4 below.

$$R = {R}_{z} ( ψ ) {R}_{y} ( θ ) {R}_{x} ( φ ) , \qquad [ Equation 3 ]$$

wherein R denotes the target rotation matrix, x, y, and z denote the target positions, and φ, θ, and ψ denote the target rotation angles.

$${R}_{x} ( φ ) = [ \begin{matrix}1 & 0 & 0 \\ 0 & cos φ & - sin φ \\ 0 & sin φ & cos φ\end{matrix} ] \qquad [ Equation 4 ]$$

$${R}_{y} ( θ ) = [ \begin{matrix}cos θ & 0 & sin θ \\ 0 & 1 & 0 \\ - sin θ & 0 & cos θ\end{matrix} ]$$

$${R}_{z} ( ψ ) = [ \begin{matrix}cos ψ & - sin ψ & 0 \\ sin ψ & cos ψ & 0 \\ 0 & 0 & 1\end{matrix} ] ,$$

wherein Rₓ denotes an x-axis rotation matrix, R_{y} denotes a y-axis rotation matrix, and R_{z} denotes a z-axis rotation matrix.

The performing 22 of initialization may involve setting the initial position and posture of the apparatus for measuring six degrees of freedom 1 by using an initialization mechanism 17.

As described above with reference to FIG. 5, in the performing 22 of initialization, after the initialization mechanism 17 is placed between the base platform 11 and the movable platform 12, the lower surface of the movable platform 12 may be brought into contact with the three spherical contact portions 173 at the upper end of the initialization mechanism 17.

According to the performing 22 of initialization, the horizontal state of the movable platform 12 may be set such that the movable platform 12 is horizontal with respect to the base platform 11, that is, horizontal with respect to the ground, while simultaneously setting posture values or sensor values of a plurality of contact-type displacement sensors 13 to an initial state.

In the measuring 23 of values from the contact-type displacement sensors 13, the controller 15 may obtain length vector information ([l₁, l₂, l₃, l₄, l₅, l₆]_{d}^{T}) of the six contact-type displacement sensors 13 based on the signals measured by the six contact-type displacement sensors 13.

In the determining 24 of six degrees of freedom of a target, the controller 15 may determine values of six degrees of freedom of the target 16 by using a numerical optimization method, based on the length vector ([l₁, l₂, l₃, l₄, l₅, l₆]_{d}^{T}) information measured by the six contact-type displacement sensors 13.

For example, in the determining 24 of six degrees of freedom of a target, the controller 15 may measure a value X_{d} ([x, y, z, φ, θ, ψ]_{d}^{T}) of the six degrees of freedom of the target 16 by using a numerical optimization method based on a Gauss-Newton method.

For example, the controller 15 may express the relationship between the length vector of the contact-type displacement sensors 13 and the value of the six degrees of freedom of the target by using a Jacobian matrix, as shown in Equation 5 below.

$$\dot{l} = J \dot{X} , \qquad [ Equation 5 ]$$

wherein J denotes the Jacobian matrix, l denotes the length vector, and X denotes the vector of the six degrees of freedom of the target.

In general, a Jacobian matrix composed of first-order partial derivatives has a highly complex formulation, and even when commercial numerical analysis programs are used, the expanded expression may span several pages. However, in a parallel robot system such as the apparatus for measuring six degrees of freedom 1 according to an embodiment, a simplified form of a Jacobian matrix, as shown in Equation 7, may be derived by using a unit direction vector (dᵢ) of the contact-type displacement sensor 13, as described in Equation 6.

$${d}_{i} = {L}_{i} / {l}_{i} , \qquad [ Equation 6 ]$$

wherein dᵢ denotes the unit direction vector of the contact-type displacement sensor 13, Lᵢ denotes the length vector of the contact-type displacement sensor 13, and lᵢ denotes the distance vector of the contact-type displacement sensor 13.

$$J = {[ \begin{matrix}{d}_{1} & {d}_{2} … & {d}_{6} \\ {Rb}_{1} \times {d}_{1} & {Rb}_{2} \times {d}_{2} … & {Rb}_{6} \times {d}_{6}\end{matrix} ]}^{T} , \qquad [ Equation 7 ]$$

wherein J denotes the Jacobian matrix, dᵢ denotes a unit direction vector of a displacement sensor (Lᵢ/lᵢ), bᵢ denotes a vector from a target point on the movable platform to an attachment point of the contact-type displacement sensor (u-v-w), and R denotes a rotation matrix of the target.

As shown in Equation 7 above, by using the cross product of the vector (bᵢ) between the target and the contact-type displacement sensor 13 and the unit direction vector (dᵢ) of the contact-type displacement sensor 13, the Jacobian matrix may be expressed in a simplified form, thereby avoiding complicated partial derivative calculations.

For example, the determining 24 of six degrees of freedom of a target may include defining 241 a cost function, performing 242 an iterative method, and checking 243 a convergence condition.

In the defining 241 of a cost function, the controller 15 may define a cost function (E), which is the sum of squared differences (e.g., see Equation 8) between the length vector measured by the actual displacement sensors and a length vector calculated from the six-degree-of-freedom model.

$${e}_{k} = {( {l}_{d} - {l}_{k} )}^{T} , \qquad [ Equation 8 ]$$

wherein eₖ denotes an error, l_{d} denotes the length vector measured by the contact-type displacement sensor, lₖ denotes the length vector calculated from the model equation, and k denotes the number of iterations (0, 1, 2, . . . , kₘₐₓ).

$${E}_{k} = {e}_{k}^{T} {e}_{k} , \qquad [ Equation 9 ]$$

wherein Eₖ denotes the cost function, eₖ denotes the error, and k denotes the number of iterations.

In the performing 242 of an iterative method, the controller 15 may estimate values of six degrees of freedom of the target 16 by performing an iterative method using a Gauss-Newton algorithm such that the defined cost function (E) is minimized.

In the performing 242 of an iterative method, the controller 15 may calculate a rate of change (∇Eₖ) of the cost function as shown in Equation 10 below, and may calculate a variation (ΔXₖ) of the vector of six degrees of freedom as shown in Equation 11 below.

$$∇ {E}_{k} = - {J}_{k}^{T} {e}_{k} , \qquad [ Equation 10 ]$$

wherein ∇Eₖ denotes the rate of change of the cost function, ΔXₖ denotes the variation of the value of six degrees of freedom, and Jₖ denotes the Jacobian matrix.

$$Δ {X}_{k} = - {( {J}_{k}^{T} {J}_{k} )}^{- 1} ∇ {E}_{k} , \qquad [ Equation 11 ]$$

wherein ∇Eₖ denotes the rate of change of the cost function, ΔXₖ denotes the variation of six degrees of freedom, and Jₖ denotes the Jacobian matrix.

Through the above process, the controller 15 may calculate a new vector (Xₖ₊₁) of six degrees of freedom, which may then be repeatedly updated for subsequent iterative calculation processes.

In the checking 243 of a convergence condition, the controller 15 may determine whether to end the performing 242 of an iterative method, based on whether the error (or cost) in each iterative calculation step has become sufficiently small or whether the maximum number of iterations has been reached.

For example, the controller 15 may determine whether to end the calculation based on whether the calculated cost function value (Eₖ) has fallen below a preset value (Eₘₐₓ) or whether the maximum number of iterations (kₘₐₓ) has been reached.

As another example, the controller 15 may determine whether to end the calculation based on whether the magnitude of the variation (ΔXₖ) in the six degrees of freedom calculated through the iterative method or the error (e) is less than or equal to a preset small value.

For example, when the controller 15 determines that the convergence condition is satisfied, the value ([x, y, z, φ, θ, ψ]ₖ^{T}) of six degrees of freedom of the target 16 may be finally determined, and the performing 242 of an iterative method may be ended. Conversely, when the controller 15 determines that the convergence condition is not satisfied, the performing 242 of an iterative method described above may be repeatedly performed.

Based on the above-described operations, the process of optimizing the values of six degrees of freedom by the controller 15 using the Gauss-Newton algorithm may be organized in the form of pseudocode, as shown in Equation 12.

[Equation 12]

```
X₀ = [0, 0, 0, 0, 0, 0]^{T} : Initialization
Do
  1. Calculation of lₖ
  2. Calculation of Jₖ
```

| | |
|---|---|
| 3. eₖ = (l_{d} − lₖ)^{T} | : Error |
| 4. Eₖ = eₖ^{T}eₖ | : Cost function |
| 5. ∇Eₖ = −Jₖ^{T}eₖ | : Rate of change of cost function |
| 6. ΔXₖ = −(Jₖ^{T}Jₖ)⁻¹ ∇Eₖ | : Variation of six degrees of freedom |
| 7. Xₖ₊₁ = Xₖ + ΔXₖ | : Calculation of undated values |
| 8. Xₖ = Xₖ₊₁ | : Undate |

While ( Eₖ ≤ Eₘₐₓ or k = kₘₐₓ )

wherein eₖ denotes the error, l_{d} denotes the length vector measured by the contact-type displacement sensor, lₖ denotes the length vector calculated from the model equation, k denotes the number of iterations (0, 1, 2, . . . , kₘₐₓ), ∇Eₖ denotes the rate of change of the cost function, ΔXₖ denotes the variation of the value of six degrees of freedom, Jₖ denotes the Jacobian matrix, and X denotes the matrix of six degrees of freedom of the target.

An apparatus and method for measuring six degrees of freedom according to an embodiment replaces the actuators of a conventional Stewart platform with contact-type displacement sensors, and enables a complex kinematics problem of obtaining six degrees of freedom of a target, based on length information measured by the contact-type displacement sensors, to be calculated in a simplified manner using numerical optimization techniques.

An apparatus and method for measuring six degrees of freedom according to an embodiment makes it possible to respond to measurement demands in various working environments with a short preparation period and may provide a simplified installation and operation method to maximize equipment utilization.

An apparatus and method for measuring six degrees of freedom according to an embodiment enables implementation with relatively low costs, compared to existing expensive apparatuses that are difficult to install and use. In addition, the measurement results may be less sensitive to changes in the surrounding environment, and installation and operation may be more convenient.

An apparatus and method for measuring six degrees of freedom according to an embodiment may be applied in a timely manner to an industrial field that may be exposed to various working environments at low operating costs, and has advantages of being easily accessible even to ordinary people without specialized knowledge due to its simple structure. Additionally, if necessary, the measuring target may be continuously connected for real-time six-degree-of-freedom monitoring and feedback purposes of the target.

The examples described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

Embodiments have been described above with reference to specific matters such as specific components and limited embodiments and with reference to drawings, but these are provided to facilitate overall understanding. Also, the present disclosure is not limited to the above-described embodiments, and various modifications and variations are possible from these descriptions by those skilled in the art to which the present disclosure pertains. Accordingly, the scope of the present disclosure is defined not by the detailed description, but by the claims and their equivalents, and all variations within the scope of the claims and their equivalents are to be construed as being included in the disclosure.

What is claimed is:

1. An apparatus for measuring six degrees of freedom, the apparatus comprising:
a base platform placed on a lower side;
a movable platform installed above and spaced apart from the base platform, and on which a target to be measured for six degrees of freedom is placed;
six contact-type displacement sensors connected between six points that are radially spaced apart on respective portions of the base platform and the movable platform with respect to a vertical direction perpendicular to the ground, and capable of extending or contracting in a longitudinal direction of the respective contact-type displacement sensors; and
a controller configured to calculate six degrees of freedom of the target through a numerical optimization method, based on values measured by the six contact-type displacement sensors.

2. The apparatus of claim 1, wherein each of the six contact-type displacement sensors comprises:
a cylinder body; and
a sliding rod having one end slidably inserted into the cylinder body and the other end protruding from the cylinder body,
wherein respective end portions of the cylinder body and the sliding rod are rotatably connected between the base platform and the movable platform.

3. The apparatus of claim 2, wherein the contact-type displacement sensors comprise a linear potentiometer, a linear variable differential transformer (LVDT), or a linear gauge.

4. The apparatus of claim 2, wherein a lower end portion of the cylinder body is rotatably connected to the base platform, and an upper end portion of the sliding rod is rotatably connected to the movable platform.

5. The apparatus of claim 1, wherein the controller is configured to estimate values of six degrees of freedom of the target by using a Gauss-Newton method, based on length vector information measured by the six contact-type displacement sensors.

6. The apparatus of claim 2, further comprising:
an initialization mechanism installed between the base platform and the movable platform, and configured to support the movable platform so as to be horizontally spaced apart from the base platform by a predetermined distance.

7. The apparatus of claim 6, wherein the initialization mechanism comprises:
three support rods extending in a vertical direction, and installed radially spaced apart from each other with respect to a central axis parallel to the vertical direction;
a connecting frame configured to interconnect the three support rods; and
spherical contact portions installed at both end portions of each of the three support rods,
wherein at least two of three spherical contact portions in contact with the movable platform are installed to be height-adjustable with respect to their respective support rods.

8. A method of measuring six degrees of freedom of a target by using an apparatus for measuring six degrees of freedom, the apparatus comprising: a base platform placed on a lower side; a movable platform installed above and spaced apart from the base platform, and on which the target to be measured for six degrees of freedom is placed; and six contact-type displacement sensors configured to connect portions that are radially spaced apart from each other on respective portions of the base platform and the movable platform,
wherein the method comprises:
defining a six-degree-of-freedom model of the target based on a length vector of the six contact-type displacement sensors;
measuring values from the six contact-type displacement sensors; and
determining values of six degrees of freedom of the target by using a numerical optimization method, based on the length vector measured by the six contact-type displacement sensors and the six-degree-of-freedom model.

9. The method of claim 8, wherein, in the defining of the six-degree-of-freedom model of the target, the six-degree-of-freedom model is defined by the following equation:
$${L}_{i} = P + R {b}_{i} - {A}_{i} ,$$
wherein Lᵢ denotes a length vector of a contact-type displacement sensor, Aᵢ denotes a vector from the center of the base platform to an attachment point of the contact-type displacement sensor, bᵢ denotes a vector from a target point on the movable platform to the attachment point of the contact-type displacement sensor, P denotes [x, y, z]^{T}, a position vector of the target, R denotes a rotation matrix of the target, and i denotes an index of the contact-type displacement sensor (1, 2, . . . , 6).

10. The method of claim 8, wherein the determining of the values of six degrees of freedom of the target comprises:
estimating the values of six degrees of freedom of the target by using a Gauss-Newton method, based on length vector information measured by the six contact-type displacement sensors.

11. The method of claim 10, wherein, in the determining of the values of six degrees of freedom of the target, a Jacobian matrix between the length vector of the six contact-type displacement sensors and a vector of values of six degrees of freedom of the target is defined by the following equation:
$$J = {[ \begin{matrix}{d}_{1} & {d}_{2} … & {d}_{6} \\ {Rb}_{1} \times {d}_{1} & {Rb}_{2} \times {d}_{2} … & {Rb}_{6} \times {d}_{6}\end{matrix} ]}^{T} ,$$
wherein J denotes the Jacobian matrix, dᵢ denotes a unit direction vector of a displacement sensor (Lᵢ/lᵢ), bᵢ denotes a vector from a target point on the movable platform to an attachment point of the contact-type displacement sensor (u-v-w), and R denotes a rotation matrix of the target.

12. The method of claim 10, wherein the determining of the values of six degrees of freedom of the target comprises:
performing an iterative method to obtain the values of six degrees of freedom of the target, such that a cost function value, which is defined as the sum of squared differences between the length vector measured by the six displacement sensors and a length vector calculated from the six-degree-of-freedom model, is minimized.

13. The method of claim 10, further comprising:
performing initialization to adjust a horizontal state of the movable platform so that the movable platform is horizontal with respect to the ground, and to set posture or sensor values of a plurality of contact-type displacement sensors to an initial state.
